(19) United States
(12) Patent Application Publication
(10) Pub. No.: US 2026/0131561 A1
(43) Pub. Date: May 14, 2026

(54) WATERPROOF AND BREATHABLE MULTI-LAYER MATERIAL

(71) Applicant: FENDENT PTE LTD, Singapore (SG)

(72) Inventors: Lee-Tung HUNG, New Taipei City (TW); Wai Ming CHOI, W. Newton, MA (US); Wan Han Max LI, Happy Valley (HK)

(73) Assignee: FENDENT PTE LTD, Singapore (SG)

(21) Appl. No.: 19/182,040

(22) Filed: Apr. 17, 2025

(30) Foreign Application Priority Data
Nov. 11, 2024 (CN) 202422740908.8

(51) Int. Cl. B32B 27/12; B32B 5/02; B32B 7/12; B32B 27/32

(52) U.S. Cl. CPC B32B 27/12; B32B 5/02; B32B 7/12; B32B 27/32; B32B 2307/724; B32B 2307/7265; B32B 2307/7376; B32B 2437/00

(57) ABSTRACT

A waterproof and breathable multi-layer material. The multi-layer material allows moisture transmission to prevent moisture accumulation and maintains resistance to liquid water penetration even when the interior surface of the multi-layer material is exposed to surface tension-reducing substances. The multi-layer material comprises a flexible textile layer and at least one layer of ultra-high molecular weight polyethylene (UHMWPE) porous membrane configured to block liquid water penetration and allow moisture transmission through the porous membrane. The porous membrane forms a barrier to prevent surface tension-reducing substances from passing through and avoids their entry into the textile layer. The method of preparing said multi-layer material is also disclosed.

### FIELD OF THE INVENTION

The present invention relates to a waterproof and breathable multi-layer material specifically designed for outdoor activities, and the method of preparing the same.

### BACKGROUND OF THE INVENTION

Existing technologies for waterproof and breathable multi-layer materials have certain limitations. For instance, Gore-Tex®, made from expanded polytetrafluoroethylene (PTFE), is widely used in outdoor apparel and equipment due to its superior breathability, durability, and waterproof performance. However, PTFE has significant environmental drawbacks. Its production involves the use of harmful chemicals that negatively impact the environment. Additionally, PTFE is non-biodegradable, leading to long-term environmental pollution when discarded. As global awareness of environmental sustainability grows, there is increasing demand for environmentally friendly alternatives, creating a demand for a high-performance yet eco-friendly replacement material.

Although some alternative technologies to PTFE exist in the market, they cannot fully match the performance of Gore-Tex®. For example, The North Face® employs nano-spinning technology to create waterproof materials using a polyurethane (PU) solution coating. While this method provides some breathability, the hydrophilic nature of polyurethane can cause it to absorb moisture over time, reducing its waterproof performance and overall effectiveness. Similarly, Pertex® Shield, which uses a PU solution coating, offers waterproof capabilities but has inferior breathability and durability compared to Gore-Tex®.

Thus, there is a pressing need for a new waterproof and breathable membrane multi-layer material that not only matches or exceeds Gore-Tex® in terms of breathability and durability but also offers superior environmental performance. Such a material must maintain a high moisture vapor transmission rate while effectively blocking liquid water penetration and withstanding prolonged use in outdoor environments, meeting the demand for waterproof, breathable, and durable materials for outdoor activities.

### SUMMARY OF THE INVENTION

According to the present invention, the multi-layer material is intended to effectively prevent water ingress into protected spaces while allowing the transmission of gases or moisture through the material to achieve breathability. Through this design, the multi-layer material provides waterproof functionality alongside excellent breathability, ensuring that it prevents the penetration of rain or external moisture while maintaining user comfort through gas exchange.

The technical advantage of the present invention lies in providing an environmentally friendly multi-layer material with both excellent waterproof performance and high breathability. The multi-layer material incorporates at least one porous polyolefin layer, particularly ultra-high molecular weight polyethylene (UHMWPE), combined with other material layers to create a structure that blocks liquid water penetration while allowing moisture transmission. Compared to traditional Gore-Tex® membranes, the porous polyolefin layer in this present invention achieves a porosity exceeding 50% and a pore size smaller than 1.0 micron. This fine microporous structure effectively prevents water ingress while providing superior moisture permeability, ensuring user comfort in harsh environmental conditions.

According to a first aspect of the invention, there is provided a waterproof and breathable multi-layer material that allows moisture transmission to prevent moisture accumulation, while maintaining resistance to liquid water penetration when the interior surface is exposed to surface tension-reducing substances. The multi-layer material comprises: a flexible textile layer; and at least one layer of ultra-high molecular weight polyethylene (UHMWPE) porous membrane, configured to block liquid water penetration and allow moisture transmission through the porous membrane, having a moisture vapor transmission rate exceeding 4,000-20,000 g/m²·24h and a water contact angle exceeding 90 degrees. The porous membrane has a thickness ranging from 5 microns to 500 microns, a porosity of at least 50%, and an average pore size smaller than 1.0 micron. The porous membrane forms a barrier to prevent the passage of surface tension-reducing substances and avoids their ingress into the textile layer.

In one embodiment, the porous membrane has a porosity ranging from 50% to 90%, an average pore size of 30 nanometers to 500 nanometers, and an elongation at break of 10% to 200%.

In one embodiment, the textile layer is laminated with at least one layer of the porous membrane, the textile layer being made of synthetic fibers, natural fibers, or a mixture thereof.

In one embodiment, the multi-layer structure is bonded using an adhesive layer, the adhesive being polyurethane (PU) or an acrylic-based adhesive.

In one embodiment, multiple porous membranes are bonded using an adhesive to form a multi-layer structure.

In one embodiment, the multi-layer material has a moisture vapor transmission rate of 10,000 g/m²/24 hours.

In one embodiment, the composite structure of the multi-layer material is capable of withstanding hydrostatic pressures ranging from 5,000 to 10,000 millimeters of water column.

In one embodiment, the multi-layer material is suitable for manufacturing waterproof and breathable outdoor clothing, tents, or other protective equipment.

Additionally, the near-zero melt index of the UHMWPE multi-layer material imparts exceptional durability and mechanical strength, enabling it to withstand prolonged wear and stretching in outdoor environments. Furthermore, the production process of polyolefin multi-layer materials is more environmentally friendly, avoiding the use of harmful chemicals. The material itself is more biodegradable, making the present invention significantly more eco-friendly compared to traditional PTFE materials. As a result, the present invention not only meets the high-performance requirements for waterproof and breathable materials but also aligns with market demands for sustainable and environmentally friendly solutions, offering broad application prospects.

According to a second aspect of the present invention, there is provided a method of preparing a waterproof and breathable multi-layer material, comprising:
a. Mixing ultra-high molecular weight polyethylene (UHMWPE) with a solvent to form a gel-like mixture, wherein the solvent is compatible with UHMWPE and is selected from paraffin oil, naphthenic oil, treated aromatic oil, or dioctyl phthalate;
b. Extruding the gel-like mixture to form a film with a uniform thickness;
c. Biaxially stretching the extruded film longitudinally and transversely to create a bi-continuous microporous structure, enhancing breathability and mechanical strength;
d. Extracting the solvent from the stretched film, wherein the solvent is removed by chemical extraction or evaporation;
e. Drying the film to stabilize the microporous structure; and
f. Laminating the porous film with at least one flexible textile layer to form a multi-layer material that is waterproof and breathable.

In one embodiment, the UHMWPE has a molecular weight ranging from 1.5×10⁶ kg/mol to 6.0×10⁶ kg/mol.

In one embodiment, the gel-like mixture has a solid content ranging from 8% to 50% by weight.

In one embodiment, the biaxial stretching is conducted at a temperature range of 100° C. to 200° C. to optimize pore connectivity and mechanical properties.

In one embodiment, the porous membrane formed has a porosity of 50% to 90% and an average pore size of 30 nanometers to 500 nanometers.

In one embodiment, the drying step is conducted under controlled conditions to preserve the microporous structure and maintain a moisture vapor transmission rate exceeding 10,000 g/m²/24 hours.

In one embodiment, the porous membrane is laminated with the textile layer using an adhesive selected from polyurethane (PU) or an acrylic-based adhesive.

In one embodiment, the method further comprising applying surface treatments to enhance adhesion between the porous UHMWPE membrane and the textile layer, wherein the surface treatment is selected from plasma treatment or chemical etching.

In one embodiment, the multiple porous UHMWPE membranes are laminated to form a composite multi-layer structure with enhanced water resistance and breathability.

In one embodiment, the flexible textile layer is selected from synthetic fibers, natural fibers, or a mixture thereof.

According to an embodiment, there is provided a method of forming a porous ultra-high molecular weight polyethylene (UHMWPE) membrane, comprising:
a. Dissolving UHMWPE in a solvent to form a homogeneous solution;
b. Extruding the solution into a film;
c. Cooling the extruded film to induce phase separation, forming a bi-continuous microporous structure;
d. Stretching the cooled film in at least one direction to enhance pore connectivity and mechanical strength;
e. Removing the solvent from the film by extraction or evaporation; and
f. Drying the film to stabilize the porous structure and obtain a breathable membrane.

### BRIEF DESCRIPTION OF THE DRAWINGS

The present invention will now be more specifically described by way of example only with reference to the accompanying drawings, in which:

FIG. 1A illustrates a schematic diagram of the layered structure of the waterproof and breathable multi-layer material of the present invention. This diagram shows the multi-layer material composed of a fiber fabric and ultra-high molecular weight polyethylene (UHMWPE), specifically including a porous UHMWPE layer and a textile layer made of synthetic fibers, natural fibers, or a mixture thereof.

FIG. 1B depicts the layered structure of the waterproof and breathable multi-layer material of the present invention, showing a scanning electron microscopy (SEM) cross-sectional image of the porous UHMWPE layer with varying porosities.

FIG. 2 presents data related to the technical parameters of the porous UHMWPE layer in the present invention.

### DETAILED DESCRIPTION OF THE PREFERRED EMBODIMENTS

The following clearly describes the technical solutions in the embodiments of the present invention with reference to the accompanying drawings. Apparently, the described embodiments are merely some but not all of the embodiments of the present invention. All other embodiments based on the embodiments of the present invention and obtained by a person of ordinary skill in the art without investing creative efforts shall fall within the scope of the present invention.

Unless otherwise specifically provided, all tests herein are conducted at standard conditions which include a room and testing temperature of 25° C., sea level (1 atm.) pressure, pH 7, and all measurements are made in metric units. Furthermore, all percentages, ratios, etc. herein are by weight, unless specifically indicated otherwise. It is understood that unless otherwise specifically noted, the materials compounds, chemicals, etc. described herein are typically commodity items and/or industry-standard items available from a variety of suppliers worldwide.

The present invention pertains to a porous ultra-high molecular weight polyethylene (UHMWPE) membrane applied to waterproof and breathable textile materials, particularly outdoor equipment such as waterproof clothing and footwear. The UHMWPE membrane is an ideal alternative to microporous polytetrafluoroethylene (PTFE) Teflon membranes, offering superior waterproof and breathable functionality. Compared to traditional multi-layer materials, UHMWPE membranes exhibit significant advantages in environmental performance and demonstrate superior strength and durability. They can endure prolonged use in harsh outdoor environments while maintaining their waterproof and breathable properties. Through lamination techniques, UHMWPE membranes combine with textile layers to form multi-layer composite materials, significantly enhancing the durability and comfort of the apparel. Additionally, the application of UHMWPE membranes ensures wearer comfort under adverse weather conditions while preventing the penetration of external moisture.

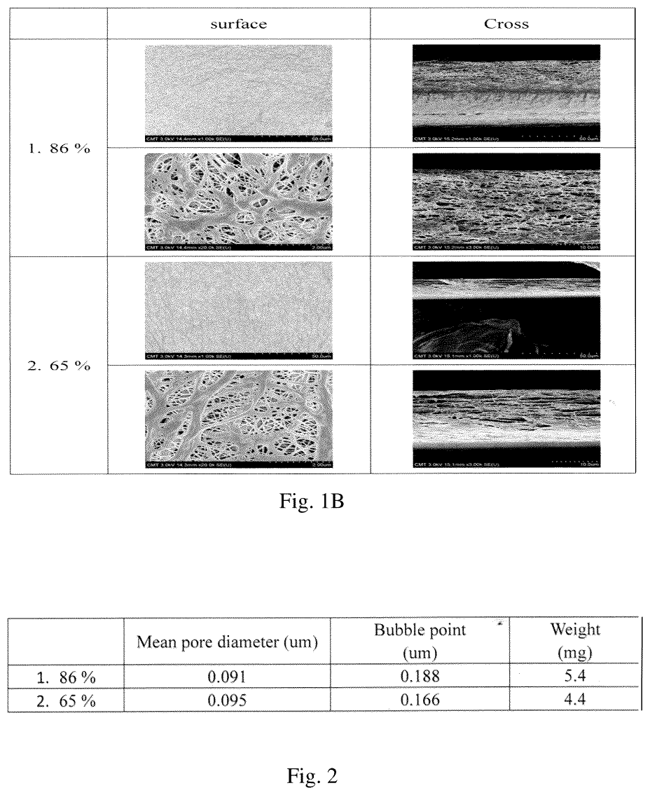

The key parameters of UHMWPE membranes are critical for achieving optimal waterproof and breathable effects. According to the present invention, the pore size of the membrane is less than 1 micron, preferably ranging from 30 to 500 nanometers. The porosity is between 50% and 90%, the thickness ranges from 5 to 500 microns, and the elongation rate is between 10% and 200%. These parameters enable the membrane to provide sufficient waterproof performance while maintaining excellent breathability and mechanical strength, making it suitable for applications in clothing and footwear. The high porosity ensures rapid moisture vapor escape, preventing internal moisture buildup and discomfort, while the small pore size effectively blocks liquid water penetration. FIG. 2 presents a data table detailing the technical parameters of porous UHMWPE membranes, such as average pore size, the weight of the membrane (measured in milligrams per area of a 2 cm diameter circle), and the bubble point. These parameters are crucial as they directly correlate with the performance indicators of the invention. The table illustrates how modifications to pore size and membrane thickness can enhance the waterproof and breathable properties of the membrane, while also maintaining its mechanical strength and durability.

The microporous structure of UHMWPE membranes features a bi-continuous structure, which ensures excellent waterproof and breathable performance. Liquid water cannot penetrate the micropores, while gases and moisture can freely pass through, ensuring breathability alongside waterproof functionality. This structure also improves the mechanical performance of the membrane, providing tear resistance and tensile strength for long-term protection in outdoor clothing and footwear. The chemical stability of the UHMWPE membrane enables it to resist external chemical substances, further enhancing its durability.

The microporous structure of UHMWPE membranes is achieved through a thermal phase separation process. This process allows precise adjustment of the membrane structure, pore size, porosity, and thickness by controlling parameters such as temperature, stretching ratio, solid content, and the characteristics and composition of polymer materials. Adjusting these parameters balances waterproof and breathable performance, meeting different application requirements. Additionally, the mechanical strength, flexibility, and durability of the membrane can be enhanced through these optimized processes, making it widely applicable in outdoor equipment.

In terms of performance, UHMWPE membranes demonstrate excellent breathability, with a moisture vapor transmission rate (MVTR) exceeding 30 mg/cm²-h. This ensures rapid moisture vapor discharge while providing waterproof protection, keeping wearers dry. The membrane's mechanical strength makes it suitable for extended use under harsh outdoor conditions, offering exceptional durability. Additionally, UHMWPE membranes exhibit excellent chemical resistance, effectively resisting water, oil, and various chemicals, ensuring long-term usability in outdoor equipment. These advantages make UHMWPE membranes an ideal material for waterproof and breathable multi-layer products, suitable for applications in clothing, footwear, and other outdoor equipment.

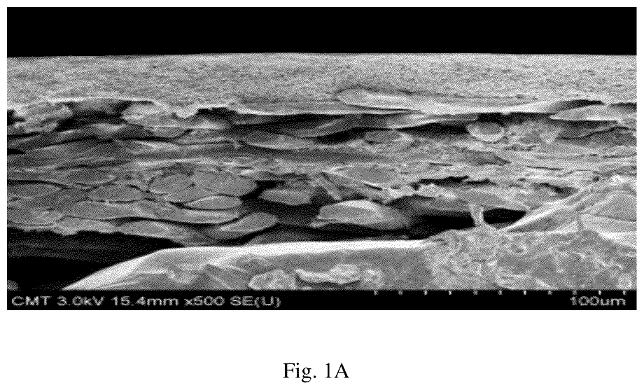

In one embodiment, the present invention provides a waterproof multi-layer material specifically designed for outdoor activities. This multi-layer material effectively prevents water ingress into protected spaces while allowing gas and moisture transmission to achieve breathability. Through this design, the multi-layer material offers excellent waterproof functionality alongside superior breathability, preventing the penetration of rain or moisture from the external environment while ensuring wearer comfort through gas exchange. FIG. 1B illustrates the structure of the porous UHMWPE membrane in the waterproof and breathable multi-layer material, highlighting the uniformly distributed micropores that enhance breathability and moisture permeability. The microporous structure ensures the waterproof and breathable performance of the multi-layer material, while the textile layer provides additional mechanical strength and durability. FIG. 1A visually depicts the close integration of the UHMWPE membrane with the textile layer, forming a multi-layer structure that blocks liquid water penetration and allows moisture transmission.

The multi-layer material structure includes at least one porous polyolefin layer. Polyolefins are a class of polymers with the general formula (CH2CHR)n, where R can be an alkyl group or a hydrogen atom. Derived from simple olefins such as ethylene and propylene, the primary commercially dominant polyolefins are polyethylene (PE) and polypropylene (PP). The present invention employs ultra-high molecular weight polyethylene (UHMWPE), characterized by a melt flow rate (MFR) close to zero. This exceptionally low MFR imparts unique physical properties to the multi-layer material, including high strength and excellent durability, making it suitable for products exposed to harsh environments over extended periods. This microporous structure blocks water penetration while allowing gases, such as moisture vapor, to pass freely, providing breathability. This microstructural design balances waterproofing and breathability, making the material ideal for outdoor activities such as mountaineering, camping, and hiking, where long-term exposure to variable weather conditions is required.

In addition, the laminated product may include at least one textile layer made of synthetic fibers, natural fibers, or blends of both. These textile layers can be tailored to provide different textures, elasticity, and abrasion resistance. To further enhance their physical properties, chemical coatings such as stain resistance, abrasion resistance, or UV resistance can be applied, increasing durability and practicality under various environmental conditions.

To prepare a UHMWPE solution film, a uniform solution must be produced between the pore forming solvent and the melted Polyethylene. Such a solution may be prepared by selecting the pore formation solvent that has certain solubility parameter range. (References: 1. Polymer handbook, 2. P. A. small: J. Applied Chem. 3, 71(1953), 3. Hilbibrand solubility parameter, 4. Hansen solubility parameter). In this case, the solubility range of the pore formation solvent is selected to be from 6 to 11 with the most suitable range from about 7.5 to 9.0. Example of suitable pore forming liquid, included paraffin oil, naphthenic oil, treated aromatic oil, Dioctyl phthalate, and the like.

Through specific processes in current technology, UHMWPE can be continuously dissolved in low-viscosity solvents below 5 mPa.s and processed into films in extruders. The advantage of this process is that it allows solution preparation and direct extrusion into films or other forms in a continuous operation. Nonetheless, solutions prepared using other methods can also be processed into microporous films through similar means.

The dissolution temperature refers to the temperature at which UHMWPE can dissolve uniformly in the solvent. When the solution cools below this temperature, gelation occurs. In the present invention, by controlling the difference between the dissolution temperature and gelation temperature, the solvent is removed from the film at temperatures below the gelation temperature, ensuring process stability. Ultra-high molecular weight polyethylene (UHMWPE) refers to polyethylene with a molecular weight of at least 4×10⁵ kg/kmol, preferably at least 8×10⁵ kg/kmol. Higher molecular weights provide films with superior physical and mechanical properties, especially high porosity and strength, but increase processing difficulty accordingly. Generally, when the molecular weight of polyethylene exceeds 1.5×10⁶ kg/mol, processing becomes more complex. However, in principle, this process can use polyethylene with even higher molecular weights. The molecular weight of UHMWPE can be determined by gel permeation chromatography or light scattering.

The UHMWPE used in the present invention is preferably 1.5×10⁶ kg/mol polyethylene, which can be obtained by known preparation methods using transition metal catalysts. UHMWPE may contain small amounts of other co-polyolefins such as propylene or butene, preferably not exceeding 5% content. Furthermore, it may be blended with other polymers such as polypropylene or polybutene, preferably not exceeding 25% content. UHMWPE may also include conventional additives such as stabilizers, antioxidants, pigments, fillers, etc.

The concentration of the UHMWPE solution can vary within a wide range, typically selecting a concentration range of 8% to 50%. Below 8%, films are fragile and difficult to process, while concentrations above 50% are challenging to handle, though suitable in certain processes. Thus, while high-concentration solutions are possible, they are generally not recommended. Solutions can be prepared into films through various methods, such as extrusion, spinning, or casting. During processing, by controlling temperature, the solution is rapidly cooled before gelation to ensure the film has sufficient strength and stability for subsequent handling.

After film formation, to promote rapid solvent removal, temperatures are usually maintained high, avoiding cooling to room temperature or below. Heated airflows (such as air) or vacuum treatments can accelerate solvent removal. To further enhance film performance, pre-stretching may be applied during solvent removal. Pre-stretching refers to the difference between forming speed and conveying speed. By adjusting this speed ratio, a predetermined stretching ratio can be obtained. During this stretching process, the film's area increases, thickness decreases, improving its strength and flexibility.

During solvent removal, films typically shrink. To prevent this, films are clamped in at least one direction. If clamped in two directions, the only reduced dimension is thickness. Similarly, for tubular films and hollow fiber films, similar methods can prevent shrinkage. In some cases, stretching treatment of films after removal can further increase their area and porosity. Film thickness decreases during stretching, but strength must remain sufficiently high to avoid breaking during the stretching process. For gel films with a thickness of approximately 1 mm, a maximum achievable area expansion rate is 70 times. With thicker films, expansion rates can reach 100 to 120 times.

Microporous films or multi-layer materials have broad applications, such as filters and waterproof and breathable materials. Furthermore, films from the present invention offer significant advantages in sealing materials, especially in pipeline thread connections. These films can be manufactured into strips of the required width, and after light uniaxial or biaxial stretching, they exhibit good flexibility, easily wrapping around threads to form efficient seals. Compared to traditional sealing materials such as polytetrafluoroethylene, UHMWPE films have non-toxic, environmentally friendly advantages, not releasing harmful substances during decomposition.

In addition, films prepared through the processes of the present invention not only possess excellent physical and mechanical properties, particularly outstanding pore structure, but also greatly reduce solvent residue, ensuring that almost no detectable solvent residues remain in the final product. This performance makes films suitable for various industrial applications, including filtration, sealing, and waterproof and breathable apparel. Through the processes of the present invention, not only can film production be efficiently achieved, but product performance and environmental friendliness can also be significantly improved.

The UHMWPE molecular weight used in the present invention typically ranges from 4×10⁵ kg/kmol to 6.0×10⁶ kg/mol, preferably 1.2×10⁶ kg/kmol polyethylene, providing films with excellent physical and mechanical properties. In a preferred embodiment, the porous polyolefin layer has a porosity of at least 50% and an average pore size of 30 to 200 nanometers. This microporous structure allows moisture and gases to pass through while blocking liquid water, making the multi-layer material both waterproof and breathable. By removing solvents and applying stretching treatment to UHMWPE films, their porosity and strength can be further enhanced. For example, during solvent removal, by applying pre-stretching, porosity can be increased to higher levels. This structure provides the multi-layer material with broad application potential in outdoor activities. The laminated multi-layer material includes at least one layer of textile material made from synthetic fibers, natural fibers, or mixed fibers. These textile layers can be further improved with chemical coatings for abrasion resistance and physical performance. The multi-layer structure of the material can be achieved through various methods, including adhesive lamination and thermal pressing techniques. These methods ensure tight bonding of the multi-layer material, achieving the desired waterproof and breathable properties.

To achieve the multi-layer structure of the waterproof and breathable material, the present invention employs various bonding processes, including adhesive lamination and hot pressing. These processes ensure that the layers of the multi-layer material are securely bonded without compromising its waterproof and breathable properties, forming durable composite multi-layer materials.

The adhesive lamination method involves applying adhesive between the layers of the material to bond them together. First, a porous UHMWPE film is aligned with a textile layer, and then a layer of adhesive is evenly applied between them. Common adhesives include polyurethane (PU) or acrylic-based adhesives. These adhesives exhibit good bonding strength when heated and do not compromise the breathability and waterproofing properties of the UHMWPE film after curing. Once the adhesive is applied, the layers are pressed together using a roller press to ensure tight adhesion and maintain stable bonding during the curing process.

Additionally, the hot-pressing method bonds the porous UHMWPE layer with the textile layer under specific temperature and pressure conditions. This method is often used for structures that do not require the addition of adhesives, to avoid potential negative effects on the material's breathability. The UHMWPE layer and textile layer are placed in lamination equipment, where heated plates provide a temperature range of 100° C. to 200° C. while applying pressure (e.g., 1 to 10 MPa). Under these conditions, strong bonding forces develop between the UHMWPE layer and the textile layer, forming a stable composite multi-layer material. The hot-pressing duration typically ranges from 10 seconds to several minutes, depending on the thickness and heating temperature of the materials used.

After the lamination process, the multi-layer material undergoes cooling and shaping to ensure interlayer bonding stability and prevent delamination or peeling during subsequent use. During cooling, the multi-layer material should maintain a certain tension to avoid wrinkles or deformation caused by shrinkage. The shaped composite multi-layer material can be cut into shapes and sizes suitable for manufacturing outdoor clothing, tents, and other products according to specific application requirements. Through these processing techniques, the multi-layer material of the present invention can maintain excellent waterproof properties while offering good breathability, durability, and comfort, making it suitable for various outdoor activity scenarios in apparel and equipment manufacturing.

By controlling the porosity of the UHMWPE layer and the overall structure of the multi-layer material, the present invention provides excellent breathability under different usage conditions. The moisture vapor transmission rate (MVTR) ranges from 4,000 to 20,000 g/m²/24 hours, depending on environmental temperature, humidity, and applied pressure.

To evaluate the waterproof performance of the multi-layer material, the present invention defines the water pressure resistance of each layer and the overall water pressure resistance of the combined layers. Tests show that a single layer of porous polyolefin material can withstand a water pressure of at least 5,000 mm H₂O, while the overall waterproof performance of the combined layers can reach 10,000 mm H₂O or higher. Such a high water pressure resistance contributes to the material's waterproofing property under extreme weather conditions.

The following is an example of preparing the abovementioned waterproof and breathable multi-layer material according to embodiments of the present invention. This example illustrates the detailed manufacturing process of the waterproof and breathable membrane designed ideal for making outdoor gears, using Ultra High Molecular Weight Polyethylene (UHWMPE) as the primary material. The process involves a series of steps, including mixing, extrusion, biaxial stretching, solvent extraction, and drying, to produce a microporous membrane with excellent breathability, water resistance, and mechanical durability. The following sections provide a comprehensive explanation of each step involved in this process.

### 1. Preparation of Raw Materials

The primary material used for this material is ultra high molecular weight polyethylene (UHWMPE), specifically the Celanese 4018 grade. This grade of UHWMPE is chosen for its superior mechanical strength, chemical resistance, and ability to form a stable gel-like substance when mixed with a solvent. These characteristics make it an ideal candidate for producing a durable and effective breathable membrane. To process UHWMPE into a film, it is mixed with paraffin oil, which acts as the solvent. Paraffin oil is selected due to its compatibility with UHWMPE and its ability to facilitate uniform gel formation. In this example, the mixture is prepared with a solid content of 20 wt%, ensuring the appropriate viscosity for the subsequent extrusion process. This ratio is crucial for achieving a consistent film thickness and maintaining the structural integrity of the membrane throughout the manufacturing process.

### 2. Extrusion and Film Formation

Once the UHWMPE and paraffin oil are thoroughly mixed, the resulting gel is fed into an extruder to form a film. The extrusion process ensures a homogeneous distribution of the polymer and solvent, resulting in a uniform film with a smooth and even surface. During extrusion, the temperature and pressure are carefully controlled to prevent any degradation of HWMPE and to maintain the desired film thickness. Extrusion is a vital step in establishing the initial structure of the membrane, as it prepares the film for the subsequent biaxial stretching process. Consistency in extrusion parameters is essential for ensuring the membrane's overall performance and durability.

### 3. Biaxial Stretching Process

Following extrusion, the film undergoes a biaxial stretching process to create a microporous structure. Biaxial stretching involves elongating the film both longitudinally (in the machine direction) and transversely (in the cross direction). This process is crucial for forming a bi-continuous porous network that enhances breathability while maintaining water resistance.

In this specific example, the film is stretched longitudinally to approximately 5.6 times its original length and transversely to approximately 6.1 times its original width. These stretching ratios are carefully selected to optimize the pore size and distribution throughout the membrane. The controlled stretching process elongates and thins the polymer network, generating interconnected micropores that facilitate water vapor permeability while preventing liquid water penetration.

The bi-continuous porous structure created through biaxial stretching is key to achieving the membrane's unique combination of breathability and water resistance. Additionally, this structure contributes to the mechanical strength and durability of the final product.

### 4. Solvent Extraction and Drying

After the biaxial stretching process, the membrane contains residual paraffin oil, which must be removed to stabilize the porous structure. Solvent extraction is employed using dichloromethane, a solvent known for its efficiency in dissolving paraffin oil without affecting the integrity of the UHWMPE structure.

During solvent extraction, the membrane is immersed in dichloromethane, which effectively removes the paraffin oil, leaving behind a stable and porous UHWMPE network. This step is followed by a drying process to eliminate any remaining solvent residues. The membrane is carefully dried under controlled conditions to preserve the microporous structure and to set the final shape and dimensions of the film.

The extraction and drying processes are critical for achieving the desired breathability and water resistance properties of the membrane. Proper execution of these steps ensures that the membrane maintains its structural integrity and performance over time.

### 5. Product Collection and Quality Analysis

Once the membrane is fully dried and stabilized, it may be wound into rolls for easy handling, storage, and subsequent processing, such as lamination onto textile fabrics. The finished membrane may then undergo rigorous testing and analysis to evaluate its performance characteristics. Key performance tests include:
Water Vapor Permeability (WVP): This test measures the membrane's breathability, ensuring that it effectively allows water vapor to pass through while blocking liquid water.
Water Resistance: The membrane is subjected to water penetration tests to verify its waterproof capabilities.
Mechanical Strength: Tensile strength tests are conducted to assess the membrane's durability and resistance to tearing or stretching during use.

The results of these tests confirm that the UHMWPE membrane achieves the necessary balance of breathability, water resistance, and mechanical strength required for high-performance outdoor gear. The microporous structure provides an effective barrier against water while allowing moisture vapor to escape, enhancing comfort and protection for the user.

The UHMWPE membrane produced using this method offers significant advantages over traditional waterproof and breathable membranes made from microporous PTFE (Teflon). Not only does it provide comparable or superior functionality, but it also addresses environmental concerns associated with PTFE. UHMWPE is more environmentally friendly due to its lower chemical processing requirements and improved recyclability.

Additionally, the bi-continuous porous structure enhances durability and flexibility, making the membrane suitable for a wide range of outdoor applications, including apparel, footwear, and equipment. Its lightweight and thin profile further enhance user comfort and ease of movement.

This detailed manufacturing example demonstrates the effectiveness of using UHWMPE to produce a high-performance waterproof and breathable membrane. By optimizing each step, from raw material preparation and extrusion to biaxial stretching, solvent extraction, and drying, the resulting membrane achieves exceptional breathability, water resistance, and mechanical strength. The process showcases a sustainable and innovative approach to developing advanced functional fabrics for outdoor gear.

It should be understood that the above only illustrates and describes examples whereby the present invention may be carried out, and that modifications and/or alterations may be made thereto without departing from the spirit of the invention.

It should be further understood that certain features of the invention, which are, for clarity, described in the context of separate embodiments, may also be provided in combination in a single embodiment. Conversely, various features of the invention which are, for brevity, described in the context of a single embodiment, may also be provided separately, or in any suitable subcombination.

All references specifically cited herein are hereby incorporated by reference in their entireties. However, the citation or incorporation of such a reference is not necessarily an admission as to its appropriateness, citability, and/or availability as prior art to/against the present invention.

1. A waterproof and breathable multi-layer material, the multi-layer material configured to allow moisture transmission to prevent moisture accumulation, while maintaining resistance to liquid water penetration when the interior surface of the multi-layer material is exposed to surface tension-reducing substances, the multi-layer material comprising:
a flexible textile layer; and
at least one layer of ultra-high molecular weight polyethylene (UHMWPE) porous membrane, configured to block liquid water penetration and allow moisture transmission through the porous membrane, having a moisture vapor transmission rate exceeding 4,000-20,000 g/m²·24 h and a water contact angle exceeding 90 degrees;
wherein the porous membrane has a thickness of 5 microns to 500 microns, a porosity of at least 50%, and an average pore size less than 1.0 micron, with the porous membrane forms a barrier to prevent the passage of surface tension-reducing substances and their ingress into the textile layer.

2. The waterproof and breathable multi-layer material of claim 1, wherein the porous membrane has a porosity ranging from 50% to 90%, an average pore size of 30 nanometers to 500 nanometers, and an elongation at break of 10% to 200%.

3. The waterproof and breathable multi-layer material of claim 1, wherein the textile layer is laminated with at least one layer of the porous membrane, the textile layer being made of synthetic fibers, natural fibers, or a mixture thereof.

4. The waterproof and breathable multi-layer material of claim 1, wherein the multi-layer structure is bonded using an adhesive layer, the adhesive being polyurethane (PU) or an acrylic-based adhesive.

5. The waterproof and breathable multi-layer material of claim 1, wherein multiple porous membranes are bonded using an adhesive to form a multi-layer structure.

6. The waterproof and breathable multi-layer material of claim 1, wherein the multi-layer material has a moisture vapor transmission rate of 10,000 g/m²/24 hours.

7. The waterproof and breathable multi-layer material of claim 1, wherein the composite structure of the multi-layer material is capable of withstanding hydrostatic pressures ranging from 5,000 to 10,000 millimeters of water column.

8. The waterproof and breathable multi-layer material of claim 1, wherein the multi-layer material is suitable for manufacturing waterproof and breathable outdoor clothing, tents, or other protective equipment.

9. A method of preparing a waterproof and breathable multi-layer material, comprising:
a. Mixing ultra-high molecular weight polyethylene (UHMWPE) with a solvent to form a gel-like mixture, wherein the solvent is compatible with UHMWPE and is selected from paraffin oil, naphthenic oil, treated aromatic oil, or dioctyl phthalate;
b. Extruding the gel-like mixture to form a film with a uniform thickness;
c. Biaxially stretching the extruded film longitudinally and transversely to create a bi-continuous microporous structure, enhancing breathability and mechanical strength;
d. Extracting the solvent from the stretched film, wherein the solvent is removed by chemical extraction or evaporation;
e. Drying the film to stabilize the microporous structure; and
f. Laminating the porous film with at least one flexible textile layer to form a multi-layer material that is waterproof and breathable.

10. The method of claim 9, wherein the UHMWPE has a molecular weight ranging from 1.5×10⁶ kg/mol to 6.0×10⁶ kg/mol.

11. The method of claim 9, wherein the gel-like mixture has a solid content ranging from 8% to 50% by weight.

12. The method of claim 9, wherein the biaxial stretching is conducted at a temperature range of 100° C. to 200° C. to optimize pore connectivity and mechanical properties.

13. The method of claim 9, wherein the porous membrane formed has a porosity of 50% to 90% and an average pore size of 30 nanometers to 500 nanometers.

14. The method of claim 9, wherein the drying step is conducted under controlled conditions to preserve the microporous structure and maintain a moisture vapor transmission rate exceeding 10,000 g/m²/24 hours.

15. The method of claim 9, wherein the porous membrane is laminated with the textile layer using an adhesive selected from polyurethane (PU) or an acrylic-based adhesive.

16. The method of claim 9, further comprising applying surface treatments to enhance adhesion between the porous UHMWPE membrane and the textile layer, wherein the surface treatment is selected from plasma treatment or chemical etching.

17. The method of claim 9, wherein multiple porous UHMWPE membranes are laminated to form a composite multi-layer structure with enhanced water resistance and breathability.

18. The method of claim 9, wherein the flexible textile layer is selected from synthetic fibers, natural fibers, or a mixture thereof.

19. A method of forming a porous ultra-high molecular weight polyethylene (UHMWPE) membrane, comprising:
a. Dissolving UHMWPE in a solvent to form a homogeneous solution;
b. Extruding the solution into a film;
c. Cooling the extruded film to induce phase separation, forming a bi-continuous microporous structure;
d. Stretching the cooled film in at least one direction to enhance pore connectivity and mechanical strength;
e. Removing the solvent from the film by extraction or evaporation; and
f. Drying the film to stabilize the porous structure and obtain a breathable membrane.

20. The method of claim 18, wherein the resulting porous membrane has a thickness ranging from 5 microns to 500 microns and a porosity of at least 50%.

21. The method of claim 18, wherein the porous membrane is laminated with a textile layer to form a waterproof and breathable multi-layer material.
